(19) United States
(12) Patent Application Publication
(10) Pub. No.: US 2012/0139762 A1
(43) Pub. Date: Jun. 7, 2012

(54) VEHICLE RECOVERY SYSTEM

(75) Inventor: MING-YANG LIAO, Tu-Cheng (TW)

(73) Assignee: HON HAI PRECISION INDUSTRY CO., LTD., Tu-Cheng (TW)

(21) Appl. No.: 13/007,961

(22) Filed: Jan. 17, 2011

(30) Foreign Application Priority Data
Dec. 3, 2010 (TW) 99142205

(51) Int. Cl. G08G 1/123

(52) U.S. Cl. 340/993

(57) ABSTRACT

A vehicle recovery system includes a position sensor and a transmitting phone. The position sensor stores a preset location value and is used for generating a notification when the displacement of the position sensor exceeds the preset location value. The transmitting phone is used for communicating with a receiving phone. The transmitting phone includes a camera module and an alarm module. The camera module is used for capturing images and sending the images to the transmitting phone. The alarm module is electrically coupled to the position sensor and used for activating the transmitting phone to communicate with the receiving phone such that the transmitting phone sends the images to the receiving phone when the alarm module receives the notification from the position sensor.

### BACKGROUND

1. Technical Field

The present disclosure relates to a vehicle recovery system.

2. Description of Related Art

Many vehicles are equipped with anti-theft systems. Yet, many measures have been developed to disable or circumvent such systems. Further, after a vehicle is stolen, identification of the perpetrator can be difficult for authorities, impeding recovery of the vehicle.

What is needed, therefore, is a vehicle recovery system to overcome the described limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is a schematic view of a motorcycle equipped with a vehicle recovery system according to an embodiment.

FIG. 2 is a block diagram of the vehicle recovery system of FIG. 1.

### DETAILED DESCRIPTION

Embodiments of the present disclosure will now be described in detail below, with reference to the accompanying drawings.

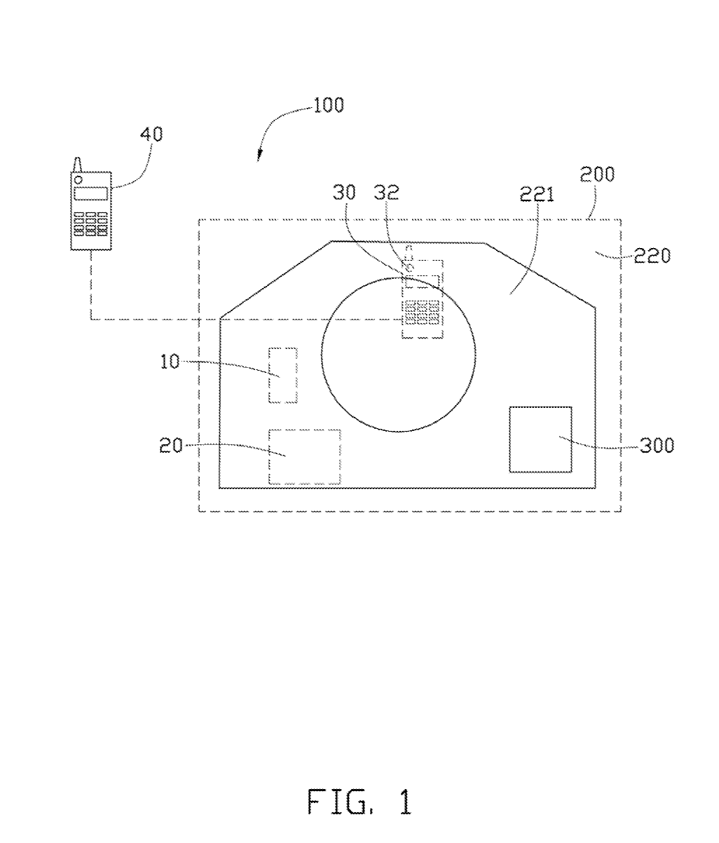

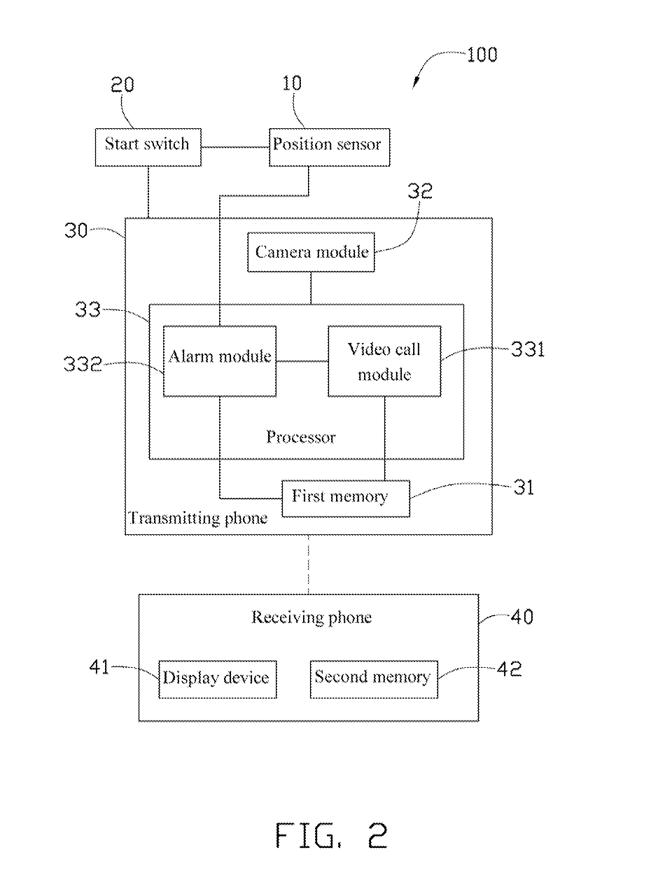

Referring to FIGS. 1 and 2, a vehicle recovery system 100, according to an embodiment, is mounted on a motorcycle 200. The vehicle recovery system 100 can be mounted on a scooter in other embodiments. The motorcycle 200 includes a power supply 300 and a handlebar assembly 220. The power supply 300 is a storage battery.

The vehicle recovery system 100 includes a position sensor 10, a start switch 20, a transmitting phone 30, and a receiving phone 40. The position sensor 10, the start switch 20, and the transmitting phone 30 are fixed on the motorcycle 200, and electrically connected to the power supply 300.

The start switch 20 is mounted on a dashboard 221 of the handlebar assembly 220 and electrically connected to the position sensor 10 and the transmitting phone 30. The start switch 20 activates position sensor 10 when the motorcycle 200 is to be left unattended.

The position sensor 10 is fixed on the motorcycle 200. In the present embodiment, the position sensor 10 is a gyroscope installed in the dashboard 221. The position sensor 10 stores a preset location value and is used for detecting the displacement of the motorcycle 200. The position sensor 10 transmits a notification to the transmitting phone 30, if the displacement of the position sensor 200 exceeds the preset location value. In the embodiment, the preset location value is 50 cm. The position sensor 10 sends a high level signal to the transmitting phone 30, if the displacement of the motorcycle 200 exceeds 50 cm.

The transmitting phone 30 includes a first memory 31, a camera module 32, and a processor 33. The transmitting phone 30 is a cell phone with a video call function, such as a 3G cell phone.

The first memory 31 pre-stores a telephone number of the receiving phone 40. The first memory 31 is a Mini SD Memory Card. The camera module 32 captures images and prepares them for video call. The camera module 32 is integrated into the transmitting phone 30. The camera module 32 is a CMOS camera module or a CCD camera module. The camera module 32 is fixed at a position of the motorcycle 200 for capturing an image of a driver's head. In the present embodiment, the camera module 32 is fixed on the dashboard 221. In other embodiments, the camera module 32 can be separated from the transmitting phone 30, and connected with the transmitting phone 30 via a data cable.

The processor 33 is connected with the first memory 31 and the camera module 32. The processor 33 includes video call module 331 and an alarm module 332. The video call module 331 receives the video data from the camera module 32, and the video call module 331 is used for calling the telephone number of the receiving phone 40, and sending video data from the camera module 32. The video call module 331 is a 3G module for video call. The alarm module 332 receives the notification from the position sensor 10 and provides the telephone number of the receiving phone 40 as a destination number for the video call module 331, directing the video call module 331 to call. When communication between the transmitting phone 30 and the receiving phone 40 is established, the alarm module 332 directs the video call module 331 to transmit video data from the camera module 32 to the receiving phone 40.

The receiving phone 40 includes a display device 41 and a second memory 42 storing video data. In the present embodiment, the receiving phone 40 is a cell phone with video call function. The receiving phone 40 is a 3G cell phone. The display device 41 is a liquid crystal display panel. The second memory 42 is a memory card. When communication is established and video data received from the transmitting phone 30, the perpetrator, now driving the motorcycle 200, is viewable. The video data is easily stored in the second memory 42, for use by authorities in recovering the motorcycle 200.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A vehicle recovery system, comprising:
a position sensor storing a preset location value and configured for generating a notification when the displacement of the position sensor exceeds the preset location value; and
a transmitting phone configured for communicating with a receiving phone, the transmitting phone comprising;
a camera module configured for capturing images and sending the images to the transmitting phone; and
an alarm module electrically coupled to the position sensor and configured for activating the transmitting phone to communicate with the receiving phone such that the transmitting phone sends the images to the receiving phone when the alarm module receives the notification from the position sensor.

2. The vehicle recovery system as claimed in claim 1, wherein the position sensor is a gyroscope.

3. The vehicle recovery system as claimed in claim 1, wherein the transmitting phone comprises a memory, the memory pre-stores a telephone number of the receiving phone; the alarm module is electrically coupled to the memory and configured for activating the transmitting phone to call the telephone number of the receiving phone when the alarm module receives the notification from the position sensor.

4. The vehicle recovery system as claimed in claim 3, wherein the transmitting phone is a 3G cell phone.

5. The vehicle recovery system as claimed in claim 3, wherein the transmitting phone further comprises a video call module, the video call module is configured for video calling and electrically coupled to the alarm module and the memory, the alarm module is configured for setting the telephone number of the receiving phone as a destination number of the video call module, and directing the video call module to send the images from the camera module to the receiving phone.

6. The vehicle recovery system as claimed in claim 3, wherein the memory is a Mini SD Memory Card.

7. The vehicle recovery system as claimed in claim 1, wherein the camera module is a CMOS camera module or a CCD camera module.

8. The vehicle recovery system as claimed in claim 1, wherein the vehicle recovery system is configured for being utilized in a motorcycle or a bicycle.

9. The vehicle recovery system as claimed in claim 1, wherein the preset location value is 50 cm.

10. The vehicle recovery system as claimed in claim 1, wherein the camera module is integrated into the transmitting phone.

11. The vehicle recovery system as claimed in claim 1, further comprising a start switch configured for activating the position sensor and the transmitting phone.
